(19) United States
(12) Patent Application Publication
(10) Pub. No.: US 2015/0067584 A1
(43) Pub. Date: Mar. 5, 2015

(54) METHOD FOR PROVIDING CONTENTS AND DIGITAL DEVICE USING THE SAME

(71) Applicant: Seungil KIM, Seoul (KR)

(72) Inventor: Seungil KIM, Seoul (KR)

(21) Appl. No.: 14/469,603

(22) Filed: Aug. 27, 2014

(30) Foreign Application Priority Data
Aug. 27, 2013 (KR) 10-2013-0101655

(51) Int. Cl. G06F 3/0485; G06F 3/0484

(52) U.S. Cl. CPC G06F 3/0485; G06F 3/04847
USPC 715/784

(57) ABSTRACT

Disclosed are a method for providing contents for adaptively adjusting an area of content which is displayed according to a user input and a digital device using the same.

There are provided a method for providing contents including: displaying a first target area of the content; receiving a user input for changing a target area of the content, the target area being an area in the content, which is displayed in a display unit; changing the target area of the content to a second target area from the first target area according to the user input, the second target area being an area which is increased compared to the first target area when a speed of the user input is equal to or higher than a predetermined speed; and displaying the second target area, and a digital device using the same.

### CROSS-REFERENCE TO RELATED APPLICATIONS

This application claims priority to and the benefit of Korean Patent Application No. 10-2013-0101655 filed in the Korean Intellectual Property Office on Aug. 27, 2013, the entire contents of which are incorporated herein by reference.

### TECHNICAL FIELD

The present invention relates to a method for providing contents and a digital device using the same, and more particularly, to a method for providing contents for adaptively adjusting an area of the content which is displayed according to a user input and a digital device using the same.

### BACKGROUND ART

A digital device represents various types of devices that can process digital data and perform an operation corresponding thereto. With improvement of performance of the digital device, various types of multimedia contents can be executed through the digital device.

Meanwhile, since the amount of contents that can be displayed at a time through a display unit is limited in the digital device, a user performs work of page turning or scrolling in order to scan all of the contents. In this case, the user may desire to rapidly scan the contents according to a situation and sometimes, may desire to scope the contents in detail by slowly scanning the contents. However, there is inconvenience that the user needs to control a speed of a page turning or scrolling operation in advance in order to control a scanning speed of the contents.

### SUMMARY OF THE INVENTION

The present invention has been made in an effort to adaptively adjust an area of a content which is displayed by determining a user's intention of scanning contents of a digital device.

An exemplary embodiment of the present invention provides a method for providing contents including: displaying a first target area of content; receiving a user input for changing a target area of the content, the target area being an area in the content, which is displayed in a display unit; changing the target area of the content to a second target area from the first target area according to the user input, the second target area being an area which is increased compared to the first target area when a speed of the user input is equal to or higher than a predetermined speed; and displaying the second target area.

Another exemplary embodiment of the present invention provides a digital device, including: a processor controlling an operation of the digital device; and a display unit outputting an image based on a command of the processor, in which the processor displays a first target area of content, receives a user input for changing a target area of the content, the target area being an area in the content, which is displayed in a display unit, changes the target area of the content to a second target area from the first target area according to the user input, the second target area being an area which is increased compared to the first target area when a speed of the user input is equal to or higher than a predetermined speed, and displays the second target area.

According to exemplary embodiments of the present invention, a digital device can accurately determine a user's intention according to a speed of a user input and provide a content to correspond thereto.

In particular, the digital device according to the exemplary embodiment of the present invention adaptively adjusts the size of an area of content which is displayed to automatically control a user's scanning speed of the content.

The present invention can be applied to various user inputs including user's scrolling, page turning, and the like of the content.

Effects of the present invention are not limited to the aforementioned effects and unmentioned effects will be clearly understood by those skilled in the art from the specification and the appended claims.

### BRIEF DESCRIPTION OF THE DRAWINGS

FIG. 1 is a block diagram illustrating a digital device according to an exemplary embodiment of the present invention.

FIG. 2 is a flowchart illustrating a method for providing contents according to an exemplary embodiment of the present invention.

FIGS. 3 to 5 are diagrams illustrating the method for providing contents according to the exemplary embodiment of the present invention.

FIGS. 6 and 7 are diagrams illustrating a method for providing contents according to another exemplary embodiment of the present invention.

FIGS. 8 and 9 are diagrams illustrating a method for providing contents according to yet another exemplary embodiment of the present invention.

FIGS. 10 to 12 are diagrams illustrating various exemplary embodiments of a user input according to the present invention.

### DETAILED DESCRIPTION

Terminologies used in the specification adopt general terminologies which are presently widely used as possible by considering functions in the present invention, but the terminologies may be changed depending on an intention of those skilled in the art, custom, or emergence of new technology. Further, when a specific terminology is defined as a predetermined meaning and used, the meaning of the terminology will be additionally disclosed. Accordingly, the terminology used in the specification should be analyzed based on not a name of the terminology but a substantial meaning of the terminology and a content throughout the specification.

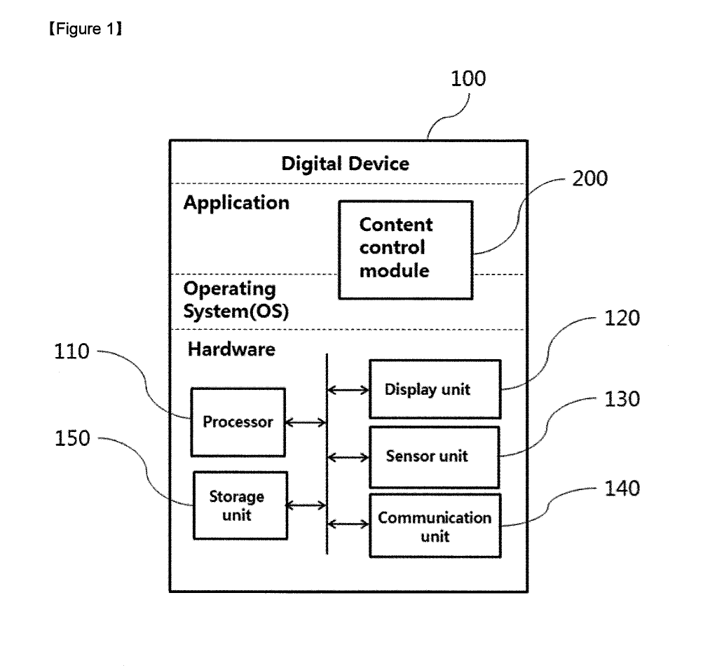

FIG. 1 is a block diagram illustrating a digital device 100 according to an exemplary embodiment of the present invention.

Referring to FIG. 1, the digital device 100 of the present invention may include a hardware layer, an operating system layer, and an application layer.

First, the hardware layer of the digital device 100 may include a processor 110, a display unit 120, a sensor unit 130, a communication unit 140, and a storage unit 150.

First, the display unit 120 outputs an image onto a display screen. The display unit 120 may output the image based on a content executed by the processor 110 or a control command of the processor 110. In the present invention, the display unit 120 may include a touch sensitive display unit.

The sensor unit 130 may detect a surrounding environment of the digital device 100 by using at least one sensor installed in the digital device 100 and transfer the detected surrounding environment to the processor 110. Further, the sensor unit 130 may detect a user input and transfer the detected user input to the processor 110. In this case, the sensor unit 130 may include at least one sensing means. As an exemplary embodiment, at least one sensing means may include sensing means such as a gravity sensor, a geomagnetic sensor, a motion sensor, a gyro sensor, an acceleration sensor, an infrared sensor, an inclination sensor, a brightness sensor, an altitude sensor, a smell sensor, a temperature sensor, a depth sensor, a pressure sensor, a banding sensor, an audio sensor, a video sensor, a global positioning system (GPS) sensor, a touch sensor, a fingerprint sensor, and the like. The sensor unit 130 is commonly called various sensing means, and senses various user inputs and an environment of the digital device 100 to transfer a sensing result so that the processor 110 performs a resulting operation. The sensors as separate elements may be included in the digital device 100 or integrated as at least one element and included in the digital device 100.

Next, the communication unit 140 communicates with an external device or a server by using various protocols to transmit/receive data. In the present invention, the communication unit 140 may access the server or a cloud through a network and may transmit/receive digital data, for example, contents. In the present invention, the communication unit 140 ma be selectively provided in the digital device 100.

Next, the storage unit 150 of the present invention may store digital data including various contents such as a video, audio, a photograph, a document, an application, and the like. The storage unit 150 includes various digital data storage media such as a flash memory, a random access memory (RAM), a solid state drive (SSD), and the like. Further, the storage unit 150 may store contents which the communication unit 140 receives from the external device or the server.

The processor 110 of the present invention may execute the contents stored in the storage unit 150 or contents received through data communication. Further, the processor 110 may execute various applications and process data in the digital device 100. When the contents executed by the processor 110 include image data, the display unit 120 may display an image of the contents executed by a command of the processor 110. In the exemplary embodiment of the present invention, the processor 110 may drive the content control module 200 and control the contents of the digital device 100 based on a control command of a content control module 200. In addition, the processor 110 may control the respective units of the digital device 100 and control data transmission/reception among the units.

Next, the operating system (OS) layer of the digital device 100 may include an operating system that controls the respective units of the digital device 100. The operating system allows the application of the digital device 100 to control and use the respective units of the hardware layer. The operating system efficiently distributes resources of the digital device 100 to prepare for an environment to execute each application. In the present invention, the operating system is used as a comprehensive concept including embedded software such as middleware, or the like. Meanwhile, the application layer of the digital device 100 may include at least one application. The application includes various types of programs to perform specific work. The application receives help of the operating system to use the resources of the hardware layer.

According to the exemplary embodiment of the present invention, the digital device 100 includes the content control module 200 for controlling the contents. According to the exemplary embodiment of the present invention described below, the content control module 200 displays the contents executed by the processor 110 on the display unit 120 and adjusts a target area of the displayed contents according to the user input. According to the exemplary embodiment of the present invention, the content control module 200 may be installed in the operating system or the application. That is, the content control module 200 may be an embedded module which is embedded in the operating system of the digital device 100 or a module provided by the application in itself.

FIG. 1 is a block diagram of the digital device 100 according to the exemplary embodiment of the present invention, and separated blocks are illustrated to logically distinguish elements of the device. Accordingly, the elements of the device may be installed as one chip or a plurality of chips according to a design of the device.

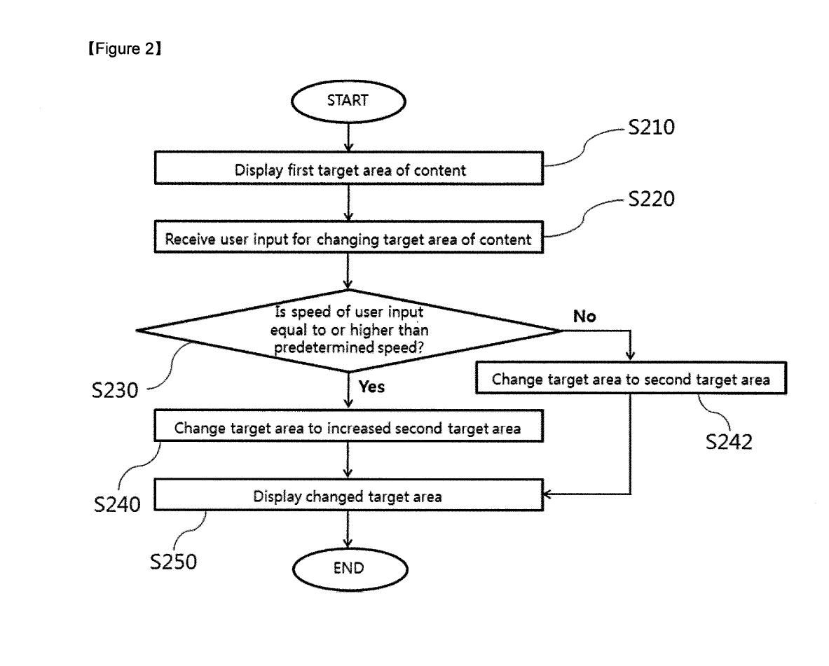

FIG. 2 is a flowchart illustrating a method for providing contents according to an exemplary embodiment of the present invention. Respective steps of FIG. 2 to be described below may be performed by the digital device of the present invention. That is, the processor 110 of the digital device 100 may control the respective steps of FIG. 2 based on the control command of the content control module 200 of the digital device 100 illustrated in FIG. 1.

First, the digital device of the present invention may display a first target area of the content (S210). In the exemplary embodiment of the present invention, the digital device sets at least a partial area of the content as a target area and displays the target area onto a display unit. In this case, the target area becomes an area of the content which is presently displayed in the display unit. In the exemplary embodiment of the present invention, the target area of the content may be defined as various exemplary embodiments. For example, the contents of the present invention may include a plurality of display pages, that is, a plurality of photographs, a plurality of document pages, a plurality of home screens, and the like. In this case, the target area of the content may include at least one of the plurality of display pages included in the contents. Further, according to another exemplary embodiment of the present invention, the target area of the contents may be predetermined map content or a partial area of a specific photograph. Hereinafter, in the present invention, the target area is used as a concept including various types of areas in the content that are displayed in the display unit.

Meanwhile, in the exemplary embodiment of the present invention, when the contents include the plurality of display pages, the plurality of display pages may be arrayed in the contents in a specific sequence. The sequence array includes all of a 1D array, a 2D array, and a 3D array. When the contents are sequenced in the 1D array, another display page included in the contents may be present in the direction of at least one of previous and next (alternatively, left and right) pages of the specific display page. Further, when the contents are sequenced in the 2D array, another display page included in the contents may be present in at least one direction of up, down, left, and right directions of a specific display page and a combination thereof. Similarly, when the contents are sequenced in the 3D array, another display page included in the contents may be present in at least one direction of forward, backward, up, down, left, and right directions of a specific display page and a combination thereto. However, the array direction described herein is a predetermined array direction for describing the sequence array of the present invention and may be modified as various exemplary embodiments.

Next, the digital device of the present invention receives a user input for changing the target area of the contents (S220). In the exemplary embodiment of the present invention, the user input includes a scroll input of the contents, a page turning input of the contents, and the like. A means for the user input includes a keyboard direction key input, a mouse click input, a mouse click and drag input, a sliding touch input, a button touch input, a gesture input, and the like and besides, includes various means for changing the display area of the contents. The user input may indicate a direction in which the target area is changed in the contents. The digital device may change the target area based on direction information included in the user input.

Meanwhile, according to another exemplary embodiment of the present invention, the user input may be received by an external sensor unit connected to the digital device. The external sensor unit may detect the user input and transfer the detected result to the digital device. That is, in the exemplary embodiment of the present invention, the user input may be detected by the sensor unit in the digital device detected by the external sensor unit to be transferred to the digital device.

Next, the digital device of the present invention determines whether a speed of the user input of changing the target area is equal to or higher than a predetermined speed (S230). In the exemplary embodiment of the present invention, the speed of the user input may be defined by various methods. According to the exemplary embodiment, the speed of the user input may be decided based on the number of input times of the user input per hour. In this case, the digital device may measure a speed of a corresponding user input based on the number of repetition times of the same user input for a predetermined time. According to another exemplary embodiment, the speed of the user input may be decided based on a change amount of the target area per hour. For example, when a user scrolls the contents by using a sliding touch input (alternatively, the mouse click and drag input), as the speed of sliding (dragging) performed in the corresponding user input is higher, the target area of the contents may be rapidly changed. In this case, the digital device may measure the speed of the user input based on a movement and change speed of the target area by the user input.

When the speed of the user input is lower than the predetermined speed in step S230, the digital device changes the target area of the contents to a second target area (S242). In this case, the second target area is an area different from the first target area and may be an area having the same size as the first target area. According to the exemplary embodiment, the second target area may be an area neighboring to the first target area and may be an area positioned in a direction indicated by the user input based on the position of the first target area.

Meanwhile, when the speed of the user input is equal to or higher than the predetermined speed in step S230, the digital device changes the target area of the contents to the increased second target area (S240). In this case, the increased second target area is an area different from the first target area and may be an area larger than the first target area. According to the exemplary embodiment, the increased second target area includes an area neighboring to the first target area and may include an area positioned in the direction indicated by the user input based on the position of the first target area. Further, the increased second target area may be an area including more display pages than the first target area.

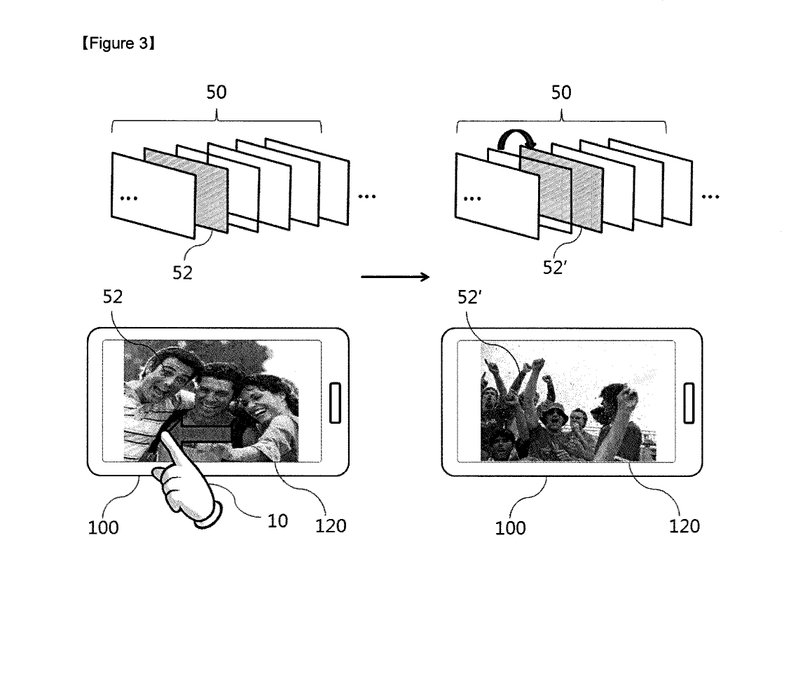

Next, the digital device of the present invention displays the target area changed through step S240 or S242 (S250). According to the exemplary embodiment of the present invention, the digital device may adjust displaying the corresponding target area based on the size of the changed target area. That is, the digital device may reduce a display scale of the second target area when the target area is changed to the increased second target area through step S240. According to another exemplary embodiment of the present invention, the digital device may provide at least one window for displaying the target area on the display unit. The digital device may display different areas of the contents through a plurality of windows. According to the exemplary embodiment of the present invention, the digital device may display the first target area in step S210 in a first window mode and the second target area increased through step S240 in a second window mode. In this case, the second window mode provides more windows than the first window mode onto the display unit together. A detailed exemplary embodiment of steps S240 to S250 will be described in detail with reference to FIGS. 3 to 9 below.

FIGS. 3 to 9 illustrate a detailed exemplary embodiment in which the digital device 100 according to the exemplary embodiment of the present invention receives user inputs 10 and 12 to change the target area of the content and displays the changed target area to correspond thereto. In FIGS. 3 to 9, the digital device 100 of the present invention receives a sliding touch input of the user as the user inputs 10 and 12. In this case, the user input 10 represents a general user input and the user input 12 represents a user input having a speed which is equal to or higher than a predetermined value. The user input 12 may include a sliding touch input of the user performed at the predetermined number of times for a predetermined time or an input of the user to rapidly perform sliding by a predetermined value or more. In the present specification, the user input 12 is called a ‘rapid user input 12’. Meanwhile, in the present invention, the user inputs 10 and 12 are not limited to the sliding touch input and may be implemented in various forms as described above.

First, FIGS. 3 to 5 illustrate an exemplary embodiment of a case in which content 50 of the present invention includes a plurality of photographs. Referring to FIG. 3, the digital device 100 may receive the user input 10 to change the target area while displaying a photograph of a first target area 52 on the display unit 120. The digital device 100 changes the target area to a second target area 52′ from the first target area 52 according to the user input 10. In FIG. 3, the digital device 100 may change the target area to the second target area 52′ positioned at a right side of the first target area 52 in terms of a sequence according to the user input 10 which slides to a left side. The digital device 100 displays a photograph of the changed second target area 52′ on the display unit 12.

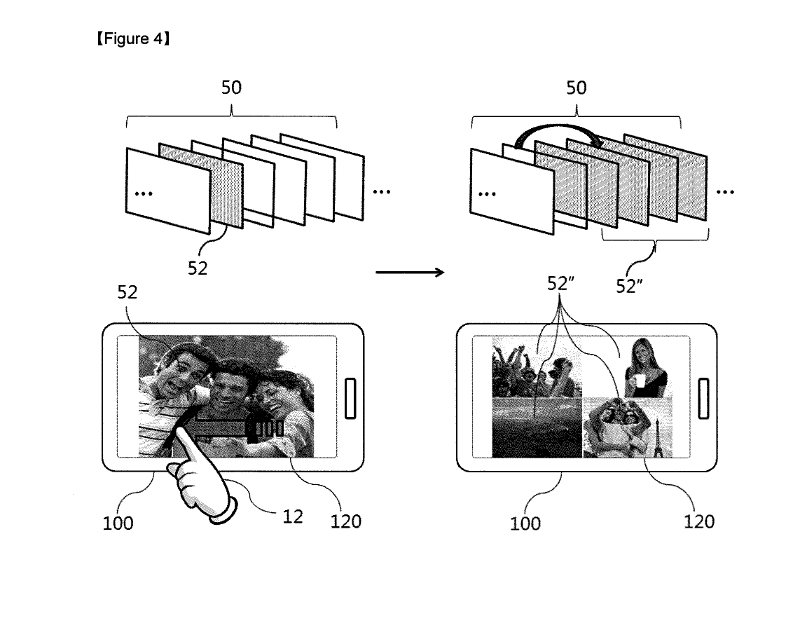

FIG. 4 illustrates an exemplary embodiment in which the digital device 100 of FIG. 3 receives the rapid user input 12. Referring to FIG. 4, the digital device 100 may receive the rapid user input 12 to change the target area while displaying the photograph of the first target area 52 on the display unit 120. The digital device 100 changes the target area to a second target area 52″ from the first target area 52 according to the rapid user input 12. In the exemplary embodiment of the present invention, the second target area 52″ is an area which is increased compared to the first target area 52. In FIG. 4, the first target area 52 is an area including one photograph of the content 50, but the second target area 52″ changed by the rapid user input 12 is an area including more areas, that is, four photographs of the content 50.

Meanwhile, according to the exemplary embodiment of FIG. 4, the digital device 100 may reduce a display scale of the second target area 52″ according to the increase of the second target area 52″. In the exemplary embodiment of FIG. 4, the digital device 100 divides a screen into four windows in order to show four photographs included in the second target area 52″ in the display unit 120 together. The four photographs included in the second target area 52″ are displayed on the respective divided windows. In this case, the digital device 100 may display the four photographs included in the second target area 52″ simultaneously by reducing the display scale of the photograph displayed on each window.

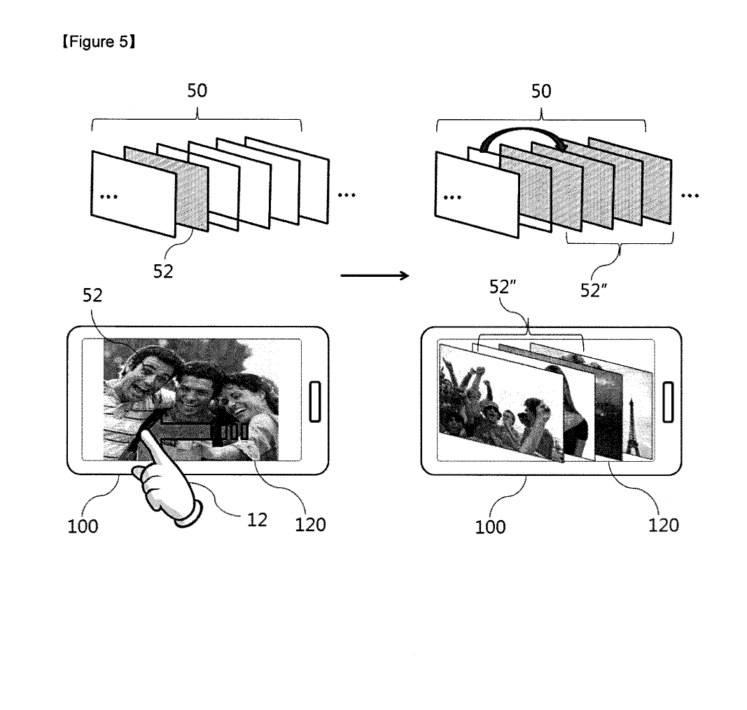

FIG. 5 illustrates another exemplary embodiment in which the digital device 100 of FIG. 3 receives the rapid user input 12. In the exemplary embodiment of FIG. 5, a part which is the same as or corresponds to the exemplary embodiment of FIG. 4 will not be described in detail. Referring to FIG. 5, the digital device 100 receives the rapid user input 12 to increase the target area to the second target area 52″, however, may maintain a display scale of a corresponding target area to be the same as the display scale of the first target area 52. To this end, the digital device 100 pans or tilts the plurality of windows of displaying the second target area 52″ to provide the panned or tilted windows. The digital device 100 allows the plurality of panned or tilted windows to overlap with each other to maintain the display scale of the second target area 52″ displayed on each window to be the same as the display scale of the first target area 52 without reducing the display scale of the second target area 52″.

In the exemplary embodiment of FIGS. 4 and 5, the digital device 100 may display the first target area 52 in the first window mode and the second target area 52″ in the second window mode. As illustrated, the second window mode provides more windows than the first window mode to display the first target area 52 onto the display unit 120. Meanwhile, when the digital device 100 receives a subsequent user input to change the target area in the second window mode, the digital device 100 may display the changed target area while maintaining the second window mode. According to another exemplary embodiment of the present invention, the digital device 100 may measure the user input to change the target area in real time and perform conversion between the first window mode and the second window mode to correspond thereto. That is, when a speed of the user input to change the target area in the second window mode is lower than a predetermined speed, the digital device 100 is restored to the first window mode to display the changed target area.

According to yet another exemplary embodiment of the present invention, when contents that remain in a change direction of the target area are equal to or less than a predetermined amount in the second window mode, the digital device 100 may display the target area changed according to the continued user inputs 10 and 12 in the first window mode. In this case, the predetermined amount may represent absolute numerical values, for example, a predetermined number of displays pages, an area having a predetermined size, and the like. Further, the predetermined amount may represent a relative numerical value, for example, a relative ratio to all contents. That is, even though the digital device 100 receives the rapid user input 12, when a sufficient amount of contents do not remain in a direction indicated by the corresponding input 12, the digital device 100 may display a new target area in the first window mode. Accordingly, when the target area of the content is changed according to the rapid user input 12, the digital device 100 according to the exemplary embodiment of the present invention may represent that the target area is close to a boundary of the content in the corresponding change direction.

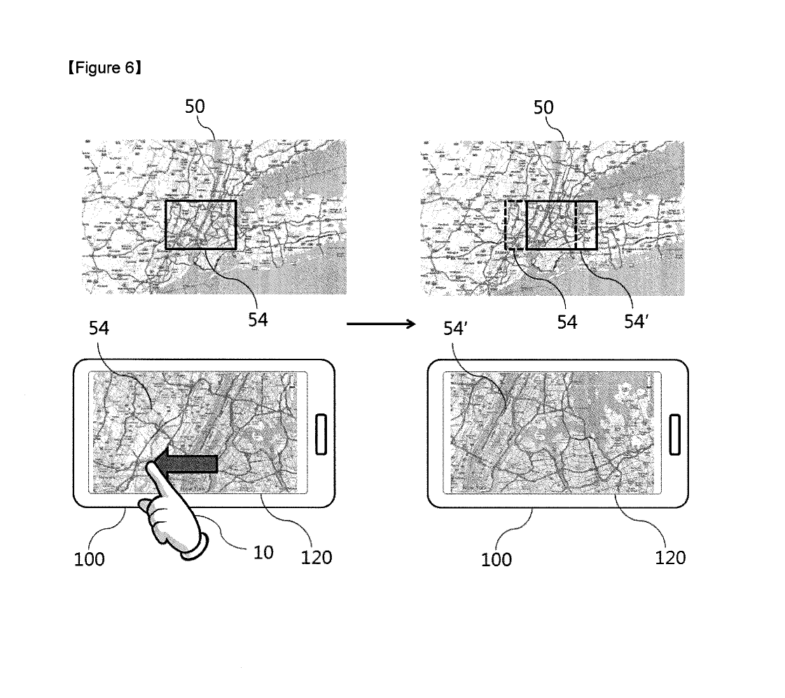

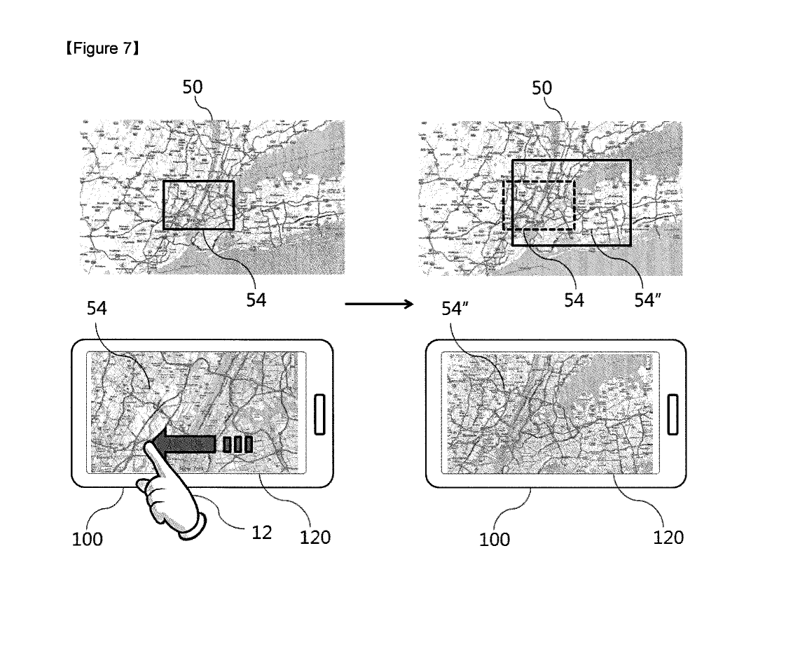

Next, FIGS. 6 and 7 illustrate an exemplary embodiment of a case in which the content 50 of the present invention includes a map content. Referring to FIG. 6, the digital device 100 may receive the user input 10 to change the target area while displaying the first target area 54 which is at least a part of the map content on the display unit 120. The digital device 100 changes the target area to a second target area 54′ from the first target area 54 according to the user input 10. In FIG. 6, the digital device 100 may change the target area to the second target area 54′ positioned at a right side of the first target area 54 on the map content according to the user input 10 which slides to a left side. The digital device 100 displays the changed second target area 54′ on the display unit 12.

FIG. 7 illustrates an exemplary embodiment in which the digital device 100 of FIG. 6 receives the rapid user input 12. Referring to FIG. 7, the digital device 100 may receive the rapid user input 12 to change the target area while displaying the first target area 54 of the map content on the display unit 120. The digital device 100 changes the target area to a second target area 54″ from the first target area 54 according to the rapid user input 12. In the exemplary embodiment of the present invention, the second target area 54″ is an area which is increased compared to the first target area 54. In FIG. 7, the second target area 54″ changed by the rapid user input 12 is an area including a larger range of the map content than the first target area 54 before the change. Meanwhile, as described in FIG. 4, the digital device 100 may reduce a display scale of the second target area 54″ according to the increase of the second target area 54″. The digital device 100 may display scale information of the corresponding target areas 54 and 54″, and the like as additional information while displaying each target area 54 or 54″.

As such, the digital device 100 according to the exemplary embodiment of the present invention may adjust the size of the displayed area to adaptively correspond to the speeds of the user inputs 10 and 12 to change an area of the content 50 to be displayed. The user may rapidly perform scrolling or page turning when the user intends to scan the content 50 rapidly. In this case, the digital device 100 of the present invention allows the user to scan the content 50 rapidly by increasing the size of the target area displayed on the display unit 120 at once.

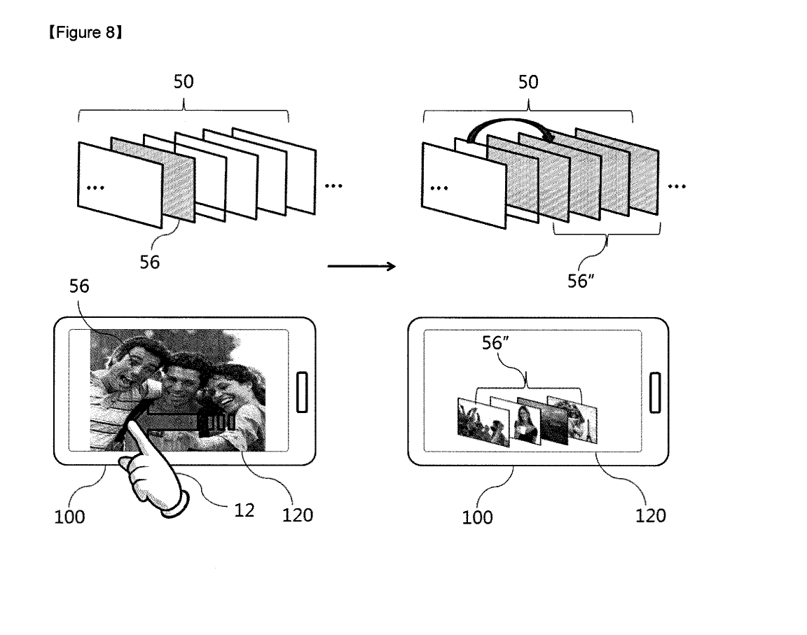

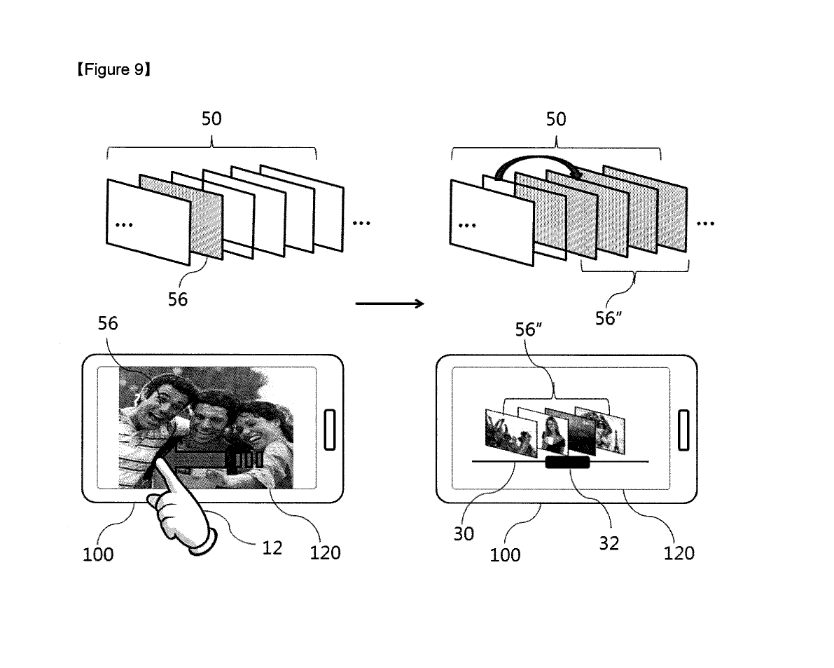

FIGS. 8 and 9 illustrate another exemplary embodiment of the present invention. In the exemplary embodiment of FIGS. 8 and 9, a detailed description of a part which is the same as or corresponds to the exemplary embodiment of FIGS. 3 to 7 will be omitted. First, referring to FIG. 8, the digital device 100 may receive the rapid user input 12 to change the target area while displaying a first target area 56. The digital device 100 changes the target area to a second target area 56″ from the first target area 56 according to the rapid user input 12. In this case, according to the exemplary embodiment of FIG. 8, the digital device 100 may display a downscaled content of the second target area 56″. In the present invention, the downscaled content represents a content having information of an amount which is smaller than information in which a corresponding target area is displayed on the display unit 120 in a basic state. For example, the downscaled content includes various types of contents including a thumbnail, an icon, a base layer picture of scalable video coding, and the like, and besides, includes various means having information of an amount which is smaller than that of actual content of the target area and representing content of the corresponding target area.

According to the exemplary embodiment of the present invention, the digital device 100 may display the second target area 56″ in the second window mode. The second window mode provides more windows than the first window mode to display the first target area 56 onto the display unit 120. According to the exemplary embodiment of the present invention, the digital device 100 may display downscaled content of the second target area 56″ in each of the plurality of windows the second window mode. Further, the digital device 100 pans or tilts the plurality of windows of the second window mode to provide the panned or tilted windows as described above.

Meanwhile, the digital device 100 may receive all contents 50 or the target area from the server or the cloud through the network in order to display the target area of the content 50 in the display unit 120. According to the exemplary embodiment of the present invention, the digital device 100 may receive the downscaled content through a communication unit (not illustrated) when displaying the downscaled content of the second target area 56″. An original content of the downscaled content may be received when there is a request from the user for the corresponding target area. As such, the digital device 100 according to the exemplary embodiment of the present invention may efficiently manage a data transmission amount when receiving and displaying the content 50 through the network in real time.

According to the exemplary embodiment of the present invention, the digital device 100 may receive content positioned in a subsequent sequence of a target area to be changed according to the user inputs 10 and 12 in advance. The content that is received in advance is content of a subsequent sequence positioned in a content change direction based on the target area to be changed. Therefore, the digital device 100 may change the target area at a high response speed and display the target area according to the continued user inputs 10 and 12. Meanwhile, according to another exemplary embodiment of the present invention, the digital device 100 may adaptively control the amount of the content which is received in advance according to the speeds of the user inputs 10 and 12. That is, when the rapid user input 12 is received, the digital device 100 may receive more contents than a case in which the general user input 10 is received in advance. For example, if the digital device 100 receives three display pages in a direction corresponding to the user input 10 in advance in the first window mode, the digital device 100 may receive ten display pages in a direction corresponding to the rapid user input 12 in advance in the second window mode.

Next, referring to FIG. 9, the digital device 100 may provide a virtual track 30 and an indicator 32 in the second window mode. The virtual track 30 connects the plurality of windows of the second window mode in the order of a sequence. The digital device 100 of the present invention may provide the virtual track 30 as a 2D track and a 3D track in addition to a 1D track illustrated in FIG. 9. Further, the digital device 100 may provide the indicator 32 that is movable along the virtual track. The digital device 100 may change the target area of the content 50 according to a user input to move the indicator 32. In the exemplary embodiment of FIG. 9, the digital device 100 may display the downscaled content of the second target area 56″ in each window of the second window mode as described in FIG. 8. Further, the digital device 100 pans or tilts the plurality of windows of the second window mode to provide the panned or tilted windows.

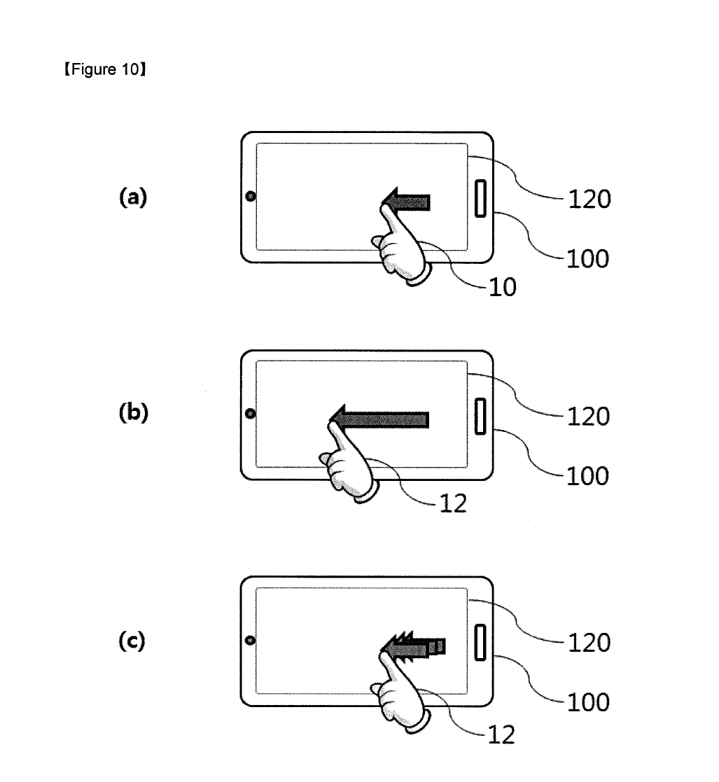

FIGS. 10 to 12 illustrate various exemplary embodiments of the user input of the present invention.

First, referring to FIG. 10, the user input of the present invention may include a sliding touch input for the digital device 100. FIG. 10A illustrates the user input 10 to change the target area and FIGS. 10B and 10C illustrate the rapid user input 12 of the present invention. According to the exemplary embodiment of FIG. 10B, the digital device 100 may recognize a corresponding input as the rapid user input 12 of the present invention when a sliding speed of the sliding touch input is equal to or higher than a predetermined speed. Further, according to the exemplary embodiment of FIG. 10C, the digital device 100 may recognize a corresponding input as the rapid user input 12 of the present invention when a sliding touch in the same direction is repeated at the predetermined number of times or more for a predetermined time.

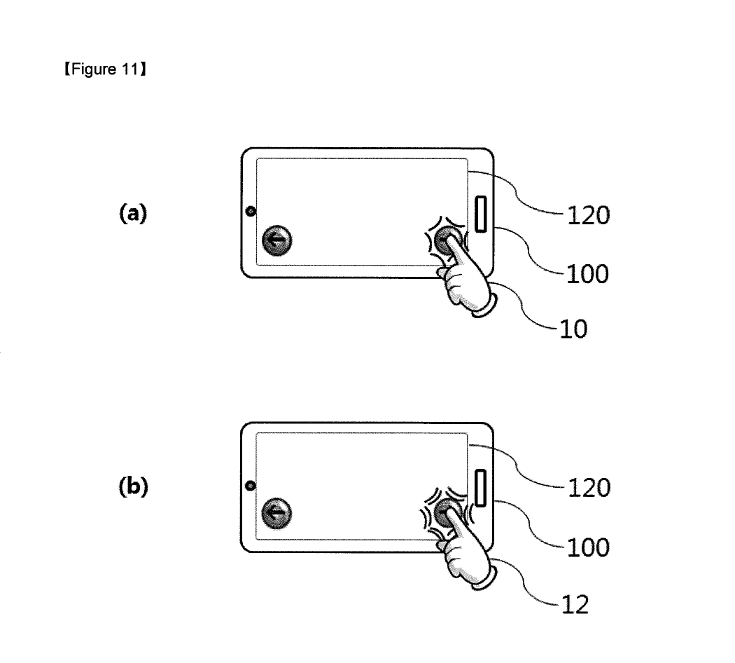

Next, referring to FIG. 11, the user input of the present invention may include a touch input of a button interface provided to the digital device 100. The button interface includes a user interface provided on the display unit 120 of the digital device 100 or a keypad separately provided in the digital device 100. The digital device 100 may change the target area based on a predetermined direction of the button interface touched by the user. FIG. 11A illustrates the user input 10 to change the target area and FIG. 11B illustrates the rapid user input 12 of the present invention. As illustrated in FIG. 11B, the digital device 100 may recognize a corresponding input as the rapid user input 12 of the present invention when the same button interface is touched repeatedly at the predetermined number of times or more for a predetermined time.

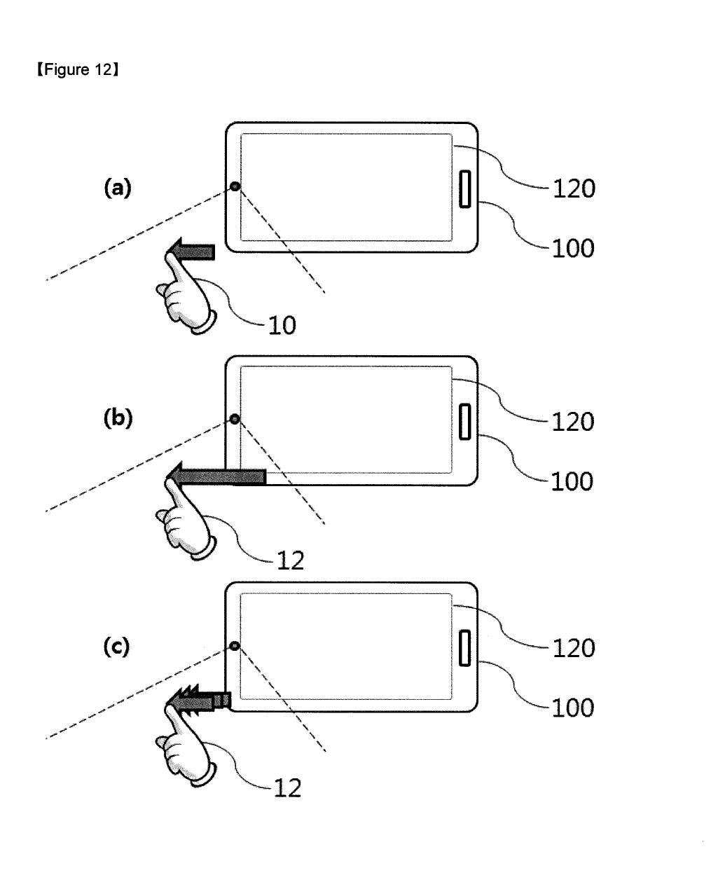

Further, as illustrated in FIG. 12, the user input of the present invention may include a gesture input for the digital device 100. In this case, the digital device 100 may include a separate sensor for detecting the gesture input. FIG. 12A illustrates the user input 12 to change the target area and FIGS. 12B and 12C illustrate the rapid user input 12 of the present invention. According to the exemplary embodiment of FIG. 12B, the digital device 100 may recognize a corresponding input as the rapid user input 12 of the present invention when a sliding speed of the gesture input is equal to or higher than a predetermined speed. Further, according to the exemplary embodiment of FIG. 12C, the digital device 100 may recognize a corresponding input as the rapid user input 12 of the present invention when the same gesture for changing the target area is repeated at the predetermined number of times or more for a predetermined time.

In the present invention, the digital device 100 includes various types of devices that may include the display unit 120 and output the content to the display unit 120, such as a TV, a personal digital assistant (PDA), a computer, a notebook computer, a mobile phone, a portable device, and the like. It will be appreciated that various embodiments of the present invention have been described herein for purposes of illustration, and that various modifications, changes, substitutions may be made by those skilled in the art without departing from the scope and spirit of the present invention. Accordingly, it is analyzed that those skilled in the art belongs to the scope of the present invention can easily induce the present invention from the detailed description and the exemplary embodiments of the present invention.

As described above, related matters have been described in a best mode for carrying out the present invention.

As described above, the present invention can be totally or partially applied to a digital device.

What is claimed is:

1. A method for providing contents, comprising:
displaying a first target area of a content;
receiving a user input for changing a target area of the content, the target area being an area in the content, which is displayed in a display unit;
changing the target area of the content to a second target area from the first target area according to the user input, the second target area being an area which is increased compared to the first target area when a speed of the user input is equal to or higher than a predetermined speed; and
displaying the second target area.

2. The method of claim 1, wherein in the displaying of the second target area, a display scale of the second target area is reduced according to the increase of the second target area.

3. The method of claim 1, wherein in the displaying of the first target area, the content is displayed in a first window mode,
in the displaying of the second target area, the content is displayed in a second window mode, and
each of the first window mode and the second window mode provides at least one window for displaying a corresponding target area, and the second window mode provides more windows than the first window mode together onto the display unit.

4. The method of claim 3, wherein in the displaying of the second target area, different areas of the content are displayed in a plurality of windows of the second window mode, respectively.

5. The method of claim 3, wherein in the displaying of the second target area, downscaled content of the corresponding target areas are displayed in a plurality of windows of the second window mode, respectively.

6. The method of claim 5, further comprising:
receiving the target area of the content through a communication unit,
wherein in the receiving of the target area, the downscaled content of the corresponding target area is received.

7. The method of claim 3, further comprising:
providing a virtual track connecting a plurality of windows of the second window mode in the order of a sequence and an indicator which is movable along the virtual track,
wherein the target area of the content is changed according to a user input to move the indicator.

8. The method of claim 3, wherein the second window mode provides a plurality of windows by panning or tilting the windows.

9. The method of claim 3, further comprising:
further receiving a user input for changing the target area of the content in the second window mode; and
displaying a target area changed according to the further received user input,
wherein in the displaying of the changed target area, when an amount of the content that remain in a change direction of the target area are equal to or less than a predetermined amount, the changed target area is displayed in the first window mode.

10. The method of claim 1, further comprising:
receiving a content positioned in a subsequent sequence of the second target area in advance according to the user input,
wherein in the receiving of the content in advance, an amount of the content which is received in advance is adaptively controlled according to a speed of the user input.

11. The method of claim 1, wherein the user input includes at least one of a scroll input and a page turning input of the content.

12. The method of claim 1, wherein the speed of the user input is decided based on the number of input times of the user input per hour.

13. The method of claim 1, wherein the speed of the user input is decided based on a change amount of the target area per hour.

14. A digital device, comprising:
a processor configured to control an operation of the digital device; and
a display unit configured to output an image based on a command of the processor,
wherein the processor is further configured to:
display a first target area of a content,
receive a user input for changing a target area of the content, the target area being an area in the content, which is displayed in a display unit,
change the target area of the content to a second target area from the first target area according to the user input, the second target area being an area which is increased compared to the first target area when a speed of the user input is equal to or higher than a predetermined speed, and
display the second target area.

15. The digital device of claim 14, wherein the processor reduces a display scale of the second target area according to the increase of the second target area.

16. The digital device of claim 14, wherein the processor displays the first target area in a first window mode and displays the second target area in a second window mode, and
wherein each of the first window mode and the second window mode provides at least one window for displaying corresponding target areas, and the second window mode provides more windows than the first window mode together onto the display unit.

17. The digital device of claim 16, wherein the processor displays different areas of the content in a plurality of windows of the second window mode, respectively.

18. The digital device of claim 16, wherein the processor displays downscaled content of corresponding target areas in a plurality of windows of the second window mode, respectively.

19. The digital device of claim 18, further comprising:
a communication unit transmitting/receiving data based on a command of the processor,
wherein the processor receives the downscaled content through the communication unit.

20. The digital device of claim 16, wherein the processor is further configured to:
provide a virtual track connecting a plurality of windows of the second window mode in the order of a sequence and an indicator which is movable along the virtual track, and
change the target area of the content according to a user input to move the indicator.

21. The digital device of claim 16, wherein the second window mode provides a plurality of windows by panning or tilting the windows.

22. The digital device of claim 16, wherein the processor is further configured to:
receive a user input for changing the target area of the content in the second window mode and display the target area changed according to the further received user input, and
display the changed target area in the first window mode when an amount of the content that remain in a change direction of the target area is equal to or less than a predetermined amount.

23. The digital device of claim 14, further comprising:
a communication unit transmitting/receiving data based on a command of the processor,
wherein the processor receives a content positioned in a subsequent sequence of the second target area through the communication unit in advance according to the user input, and
an amount of the content which is received in advance is adaptively controlled according to a speed of the user input.

24. The digital device of claim 14, wherein the user input includes at least one of a scroll input and a page turning input of the content.

25. The digital device of claim 14, wherein the speed of the user input is decided based on the number of input times of the user input per hour.

26. The digital device of claim 14, wherein the speed of the user input is decided based on a change amount of the target area per hour.
